(19) United States
(12) Patent Application Publication
(10) Pub. No.: US 2009/0100503 A1
(43) Pub. Date: Apr. 16, 2009

(54) AUTHENTICATION FOR SHARED WIRELESS PERIPHERALS HAVING AN INTERNAL MEMORY STORE FOR SHARING DIGITAL CONTENT ACROSS MULTIPLE HOSTS

(75) Inventor: RONALD P. DOYLE, RALEIGH, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/872,364

(22) Filed: Oct. 15, 2007

(51) Int. Cl. H04L 9/32

(52) U.S. Cl. 726/3

(57) ABSTRACT

The present solution can authenticate a first host to access a memory space of a shared wireless peripheral communicatively linked to the first host via a bus and a device controller. Digital content displayed within a graphical user interface of the first host can be selected. Either a CUT or COPY clipboard operation can be detected that is conducted from the first host. The selected content can be copied to the memory space of the peripheral. The second host can be authenticated to access a memory space of the peripheral communicatively linked to the second host via a bus and a device controller. A PASTE clipboard operation conducted from the second host can be detected. The selected content obtained from the first host can be conveyed from the memory space of the shared wireless peripheral to a cursor specified location within a graphical user interface of the second host.

### BACKGROUND

1. Field of the Invention

The present invention relates to the field of peripheral devices and digital content sharing and, more particularly, to authentication for shared wireless peripheral devices having an internal memory store for sharing digital content across multiple hosts.

2. Description of the Related Art

A computer peripheral generally refers to an optional piece of computer hardware that is added to a host computer in order to expand its abilities. Peripherals are typically external to the host computer and are linked through a bidirectional universal switch (bus), such as a universal serial bus (USB). Peripherals include mice, trackballs, game controllers, joysticks, keyboards, and the like. Many peripherals are wireless and permit communications using a wireless protocol, such as BLUETOOTH, wireless USB, etc.

A number of peripheral devices are emerging that include an internal storage space. These devices are generally being marketed as being dual purpose devices that consume only one port, such as a USB port, instead of consuming two ports by using two devices. An example of this type of device is a flash memory mouse, which can include 1 GB of storage space used as an additional memory cache to improve performance of a host without increasing RAM and/or to be used as an external storage device for storing digitally encoded content. Additionally, innovators have contemplated using memory of a peripheral to share information between multiple host systems, as notable by U.S. Pat. No. 6,933,919 to Anderson, et al. (Anderson), U.S. Pat. No. 6,591,308 to Cummings, et al. (Cummings), U.S. Pat. No. 6,720,948 to Martinez (Martinez), and U.S. Pat. No. 6,813,630 to Sanamrad (Sanamrad). At present, however, no peripheral device containing memory and having an ability to share information between two or more host systems has emerged in the market.

One reason for this lack of market presence is that a myriad of heretofore unsolved problems exist. For example, the Anderson patent (U.S. Pat. No. 6,933,919) specifies that in a preferred embodiment, the peripheral device including memory is a USB device, which at the time of filing was before an emergence of wireless USB. Any wired peripheral is generally too cumbersome to be utilized for standard information sharing operations. It is more convenient to save information to a network space or to use a USB storage key than to save information to a peripheral connected by wire to one host, to disconnect the peripheral from the first host, then to connect the peripheral to a second host.

A problem with wireless flash peripherals is that they must be able to connect to multiple host computers. A current state of the art proposes that a wireless device will initially be connected to a first host, information will be transferred from that first host to an internal memory, the device will disconnect from the first host and reconnect with a second host, and information will be transferred from the internal memory to the second host. One problem with this approach is an intermediate loss/addition of input functionally associated with the peripheral when connected and disconnected. Significant latency can result due to auto detection software on both hosts responding to the connection/disconnections. Another problem is that inherently, the peripheral memory becomes a security weakness for either host. Still another problem is that conflicts will occur in a workplace that contains two or more wireless flash containing peripherals that are within wireless range of a common host. Conflicts also exist in determining which of multiple hosts is to “own” a wireless peripheral device. No known approach adequately addresses security concerns, conflicts, and/or latency issues involved with sharing information between two host devices via a wireless peripheral.

### SUMMARY OF THE INVENTION

The present invention discloses a solution for authenticating hosts with a shared wireless peripheral device having an internal memory store for sharing data across multiple hosts. For example, a shared wireless peripheral can be a flash memory containing mouse, where the in-peripheral memory is used to transfer digital content between hosts. In one embodiment, content transfers can result from extended variants of clipboard commands (e.g., CUT, COPY, PASTE, etc.). The present invention can use a security artifact to authenticate and authorize the shared wireless peripheral to connect to a host. Different levels of permissions can be established for controlling input functions (e.g., standard mouse functions) and for controlling data sharing functions. Authentication can prevent the shared wireless peripheral from becoming an exploitable security weakness for gaining unauthorized access to a host. The authentication and authorization process can also ensure potential conflicts between multiple hosts and a multiple shared wireless peripherals are properly handled. In one embodiment, the authentication can require a host to provide input from a different peripheral when authorizing the host to control the shared wireless peripheral. This ensures that a user having access to the host authorizes communications between the shared wireless peripheral and the host.

The present invention can be implemented in accordance with numerous aspects consistent with the material presented herein. For instance, one aspect of the present invention can include a shared wireless peripheral that includes a memory space and an authentication engine. The memory space of a shared wireless peripheral device can be configured to store digital content. The authentication engine can determine whether a host is granted access to the memory space based upon a security artifact received from the host. The shared wireless peripheral device can be configured to receive digital content from one host, to store the received digital content in the memory space, and to convey the stored digital content to a different host.

Another aspect of the present invention can include a method for using clipboard operations to transfer content between different hosts of a shared wireless peripheral. The method can include a step of authenticating a first host to access a memory space of a shared wireless peripheral communicatively linked to the first host via a bus and a device controller. Digital content displayed within a graphical user interface of the first host can be selected. Either a CUT or COPY clipboard operation can be detected that is conducted from the first host. The selected digital content can be copied to the memory space of the shared wireless peripheral. The second host can be authenticated to access a memory space of a shared wireless peripheral communicatively linked to the second host via a bus and a device controller. A PASTE clipboard operation conducted from the second host can be detected. The selected digital content obtained from the first host can be conveyed from the memory space of the shared wireless peripheral to a cursor specified location within a graphical user interface of the second host.

Still another aspect of the present invention can include a software program that includes programmatic instructions stored on a computing device readable medium. The programmatic instructions can be executed by a computing device, which is either a shared wireless peripheral or a host. The programmatic instructions can require a user input from an input device connected to the host before digital content is permitted to be exchanged between a data store of the host and a memory space within the shared wireless peripheral. The shared wireless peripheral device can be configured to receive digital content from one host, to store the received digital content in the memory space, and to convey the stored digital content to a different host.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system of a shared wireless peripheral able to receive, store, and provide data from/to a number of hosts via a wireless connection.

FIG. 2 is a schematic diagram of a mouse embodiment of a shared wireless peripheral in accordance with an embodiment of the inventive arrangements disclosed herein.

FIG. 3 is a flow chart of a method for authenticating hosts to interact with a shared wireless peripheral in accordance with an embodiment of the inventive arrangements disclosed herein.

FIG. 4 is a flow chart of a method for using a shared wireless device to permit clipboard operations to convey digital content between different hosts in accordance with an embodiment of the inventive arrangements disclosed herein.

### DETAILED DESCRIPTION OF THE INVENTION

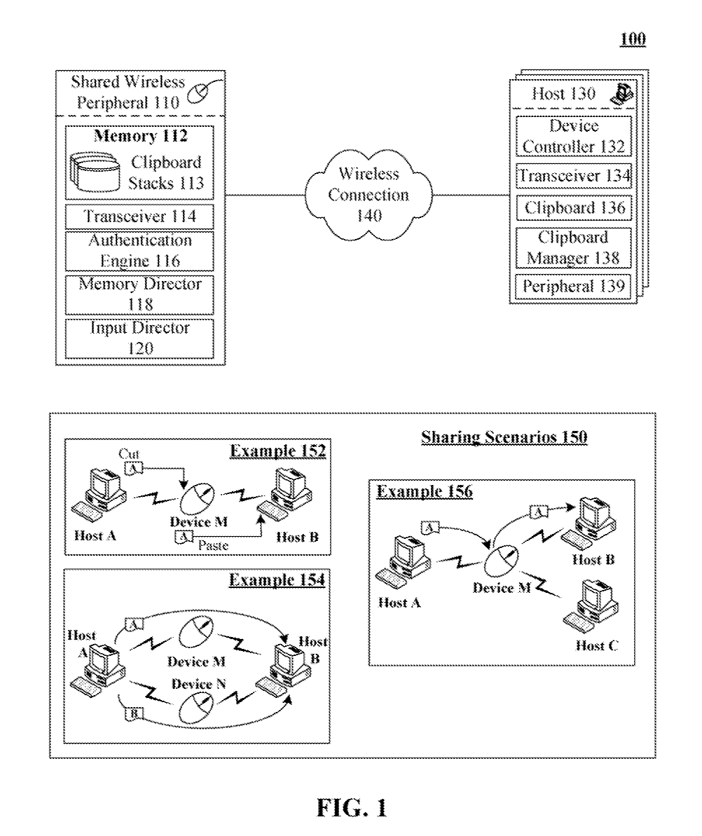

FIG. 1 is a schematic diagram illustrating a system 100 of a shared wireless peripheral 110 able to receive, store, and provide data from/to a number of hosts 130 via a wireless connection 140. The peripheral 110 can include any of a variety of peripheral device, which include a mouse, a trackball, a joystick, a game controller, a printer, a scanner, a wireless remote control, a wireless keyboard or keypad, and the like. The peripheral 110 can include an internal memory 112 space within which data from one host 130 can be stored and conveyed to a different host 130. For example (example 152), a cut or copy operation can be performed by Host A, which can convey Content A to Device M. A Host B can then perform a paste operation, which results Content A being conveyed from Device M to Host B. Transceivers 114 and 134 can be used for sending and receiving digitally encoded content over wireless connection 140.

The shared wireless peripheral 110 can include an authentication engine 116, which adds authentication and authorization for the device 110. One security function performed by engine 116 can control whether device 110 is able to interact with a particular host 130 in a particular manner. Input functionality and/or data sharing functionality can be distinct capabilities of peripheral 110, which can be separately granted to hosts 130 by authentication engine 160.

Input functionality can refer to an ability of peripheral 110 (e.g., a mouse, joystick, a game controller, a trackball, a keyboard, etc.) to send input to host 130, which can control a computing environment of host 130. For example, the wireless peripheral 110 can be a mouse, and input functionality can send pointer control directions, mouse click events, and scroll wheel events to a host 130. The input director 120 can handle input functions involving peripheral 110 and one or more authorized hosts 130.

Data sharing functionality can refer to whether peripheral 110 is able to receive and store digital content from a host 130 as well as whether a host 130 is able to retrieve information stored within memory 112 of peripheral 130. When two hosts 130 are authorized by engine 116 to share digital content, the content can be moved between the different authorized hosts via peripheral 110. A memory director 118 can handle data sharing functions involving authorized hosts 130. In one embodiment, the memory director 118 can provide different permissions to different hosts 130, such as read, write, update, and delete privileges. The memory director 118 can further permit host-defined groups to share content with each other, similar to network shared permissions established for conventional network data stores. Various security technologies, such as passwords, certificates, public keys, encryption technologies, etc., can be used by the memory director 118 to selectively protect content placed in memory 112. Further, system 100 can optionally use data conveyance security technologies to protect content as it is being conveyed between peripheral 110 and host 130 over wireless channel 140. Further, validation and re-transmission technologies (e.g., checksums with automatically retransmission requested) can be implemented in system 100 to ensure that connection 140 correctly conveys digital content between peripheral 110 and host 130.

The authentication engine 116 can authorize a host 130 for input operations with a peripheral 110 without authorizing the host 130 for data sharing functions and can authorize data sharing functions without authorizing the host 130 for input operations. For example (example 156), Host A can be authorized by engine 116 for input functionality and data sharing functionally involving Device M. Host B can be authorized only for data sharing functionality involving Device M. Host C can be authorized only for input functionality involving Device M. Thus, Device M can be a mouse that controls a pointer of Host A or Host C depending on which host (A or C) currently owns Device M, which can be switched from one device to the other based upon a user selection. The Host A and Host B can both be authorized by engine 116 for data sharing functions, which permits Content A to be conveyed between Host A and Host B through a memory 112 of Device M. In example 156, Host C is not authorized by engine 116 for data sharing and so Host C cannot use Device M to exchange content between itself and Host A or Host B. Host B is not authorized by engine 116 for input functionality so it cannot receive pointer movement instructions, click events, key presses, and other such information from Device M.

The authentication engine 116 can also prevent conflicts involving peripheral 110 from occurring. Conflicts can include which host 130 is currently receiving input from peripheral 110, which host 130 is to convey information to memory 112, and/or which host 130 is to receive content from memory 112. Conflicts handled by engine 116 can also include which of many possible devices 110 are interacting with which proximate hosts 130. For example (example 154), Device M and Device N can both be within wireless range of Host A and Host B. Assuming Hosts A and/or B are able to execute data sharing commands involving Device M or N, such as Get_Device_Memory_Item or Put_Device_Memory, a command issuing host must know to which Device M or N the data sharing command pertains. Authentication engine 116 and directors 118, 120 can implement conflict resolution and information direction features at an arbitrary level of complexity as long as deterministic rules are established using a set of programmatic instructions.

The host 130 can include a device controller 132, which manages device drivers used to connect the host to the shared wireless peripheral 110. The host 130 can include one more additional peripheral 139 devices, such as a keyboard. In one embodiment, an input from peripheral 139 can be required when authenticating peripheral 110 for use with host 130.

The host can also include a clipboard 136 and a clipboard manager 138. The clipboard 136 can be a memory space in which content resulting from clipboard operations (e.g., CUT, COPY, PASTE) are stored. The clipboard manager 138 can be a software program with manages the clipboard operations. In one embodiment, clipboard commands can be used to place selected content within the memory 112. Further, the memory 112 can include one or more different clipboard stacks 113. The different clipboard stacks 113 can be used when multiple different hosts 130 are able to place digital content in the memory 112 using clipboard commands. Different hosts 130 can be authorized to use different clipboard stacks 113.

For example, a Host A can (external) CUT content to Stack A (from stacks 113) while a HOST B concurrently is able to (external) COPY content to Stack B. Assume Host A authorizes Host C to retrieve content from Stack A and Host B authorizes Host D to retrieve content from Stack B. When Host D performs an (external) PASTE, content placed in Stack B by Host B can be returned. When Host C performs an (external) PASTE, content placed in Stack A by Host A can be returned.

In one embodiment, special clipboard commands can be established for directing clipboard functions to be local only, external only, or a combination of the two. In another embodiment, a clipboard extension program can be added to the hosts 130 to implement data sharing functionality via peripheral 110 without having to re-code the clipboard manager 138. For example, the clipboard extension program can detect when content is added to clipboard 136, which conveys that content to an appropriate stack 113. Similarly, content can be received from memory 112, which the clipboard extender program places in a suitable memory space of clipboard 136, such as placing a newly pasted item on top of the local clipboard 136 so that local PASTE operations (using manager 138) add the content from memory 112 to an active application executing on host 130.

It should be appreciated that illustrative scenarios 150 are provided to show examples 152-156 of how a peripheral 110 facilitates information sharing. In scenarios 150, peripheral 110 is referenced as Device M or Device N and host 130 is referenced as Host A, Host B, and/or Host C. The examples 152-156 are not intended to be exhaustive and the scope of the invention is not to be construed as limited to scenarios shown by the examples 152-156.

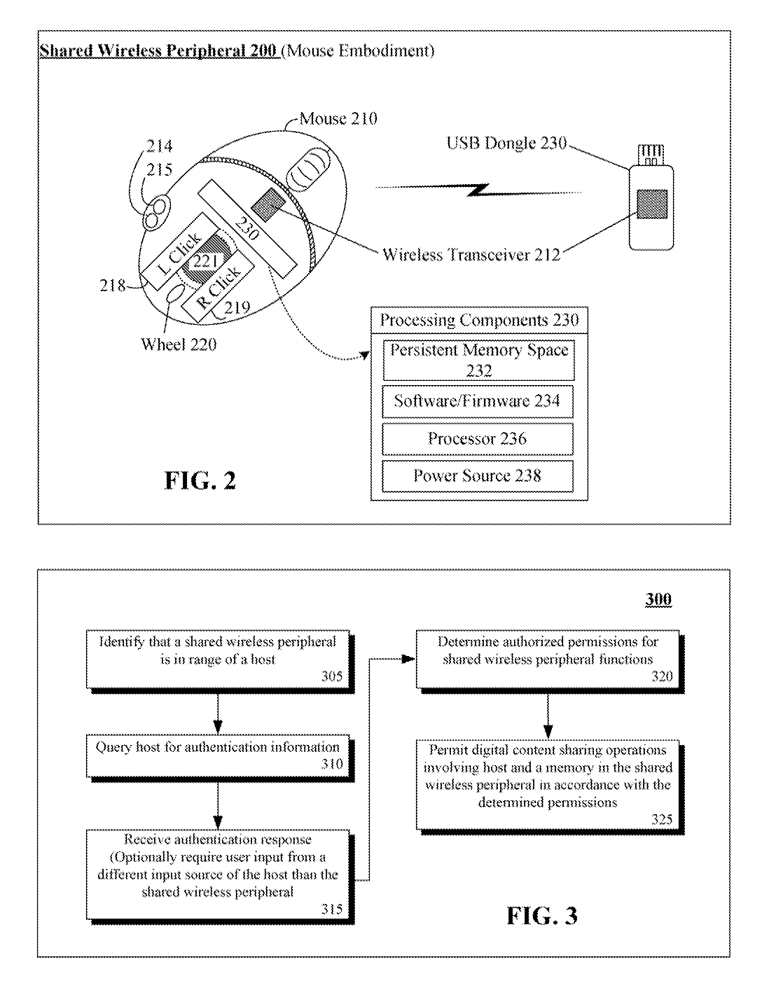

FIG. 2 is a schematic diagram of a mouse embodiment of a shared wireless peripheral 200 in accordance with an embodiment of the inventive arrangements disclosed herein. The peripheral 200 is one contemplated implementation of peripheral 110 from system 100. Peripheral 200 is shown for illustrative purposes only and other types of shared wireless peripherals are contemplated, as explained in system 100.

Peripheral 200 can include a wireless mouse 210 that wirelessly exchanges data with USB dongle 230 via wireless transceivers 212. The USB dongle 230 can connect to a USB port of a host computer. Typically the wireless connection between mouse 210 and dongle 230 will be a radio frequency one, although infrared and other electromagnetic spectrum ranges can also be used. Multiple USB dongles 230 can exist for a single mouse 210, which permits the dongles 230 to be connected to different hosts. Alternatives to USB dongles 230 can be used so long as the alternative component can send/receive information from mouse 210 and can convey the information to a host to which the component is connected.

The mouse 210 can include standard mouse features, such as a left click 218 selector, a right click selector 219, a scroll wheel 220, and a movement detector 221. Additionally, mouse 210 can include user selectable elements (e.g., buttons, force response regions, etc.) 214, 215. Element 214 can be used to change which of many possible hosts the mouse 210 is connected to. In one embodiment, input from a host peripheral other than the mouse 210 will be required to successfully connect the mouse 210 to the host. Different hosts can be associated with unique key values and/or security keys/certificates that prevent conflicts and that provide security. Element 215 can toggle shared data options. For example, a short press of element 215 can toggle an enablement state for permitting the current host to place data (e.g., CUT and COPY operations for example) into a persistent memory space 232. A long press of element 215 can toggle an enablement state for permitting the current host to retrieve data (e.g., PASTE operations) from the persistent memory space 232. Any number of user selectable elements 214, 215 can be included to permit user control of data sharing functions/setting involving the mouse 210.

The mouse 210 can include a various processing components, such as a persistent memory space 232, software/firmware 234, a processor 236, and/or a power source 238. Digital content received from/sent to remotely located hosts can be stored in the persistent memory space 232. The software/firmware 234 can include numerous set of executable programmatic instructions, such as an authentication engine program, a memory director program, and/or an input director program. Processor 236 can be an in-mouse 210 processing unit that executes the software/firmware 234. In one contemplated embodiment, the processing components 230 shown as being contained within peripheral 200 can reside within a host controlling the peripheral 200. Thus, in one embodiment, a processor 236 can be a processor of the host using peripheral 200 and need not be included in peripheral 200 itself.

FIG. 3 is a flow chart of a method 300 for authenticating hosts to interact with a shared wireless peripheral in accordance with an embodiment of the inventive arrangements disclosed herein. Method 300 can be performed in the context of a system 100.

Method 300 can begin in step 305, where a software program can identify that a shared wireless peripheral is in range of a host. In optional step 310, the peripheral can query the host for authentication information. Step 310 is not necessary in an embodiment, where hosts automatically provide authentication information to the shared wireless peripheral without being prompted. In step 315, an authorization response can be conveyed from the host to the shared wireless peripheral.

The response can include an automated response, such as when a software program provides a previously established authorization key, token, certificate, or password to the shared wireless device to authenticate the host. The response can also or alternatively include a user input from another host peripheral device, such as a keyboard, which is used to authenticate the host. Reliance upon a user input can ensure that an authorized user is currently logged onto the host and permits the host to utilize capabilities of the shared wireless device. These authentication measures ensure that the shared wireless device is not a vector for obtaining unauthorized access to the host, either to receive digital content from the host or to convey digital content to the host. These security measures can be extremely important as communications between the shared wireless peripheral can occur via a bidirectional universal switch (bus) associated with peripherals that can bypass other host security measures (e.g., firewall settings protecting network ports, malware and antivirus programs protecting against email and removable media intrusions, etc.). Although the method indicates that active steps are being performed by the shared wireless device, in a contemplated derivative of method 300 authorization software can be present in one or more hosts, which can execute in place of executing authorization software within a shared wireless peripheral to achieve equivalent results. Similarly, execution flow can be directed to any processing element external to the shared wireless device and the host to achieve equivalent results.

In step 320, a set of authorized permissions for shared wireless peripheral functions can be determined based upon the received response. The peripheral functions can include data sharing functions as well as input functionality. In step 325, data sharing (and input) operations involving the host and the shared wireless peripheral can be permitted in accordance with the determined permissions.

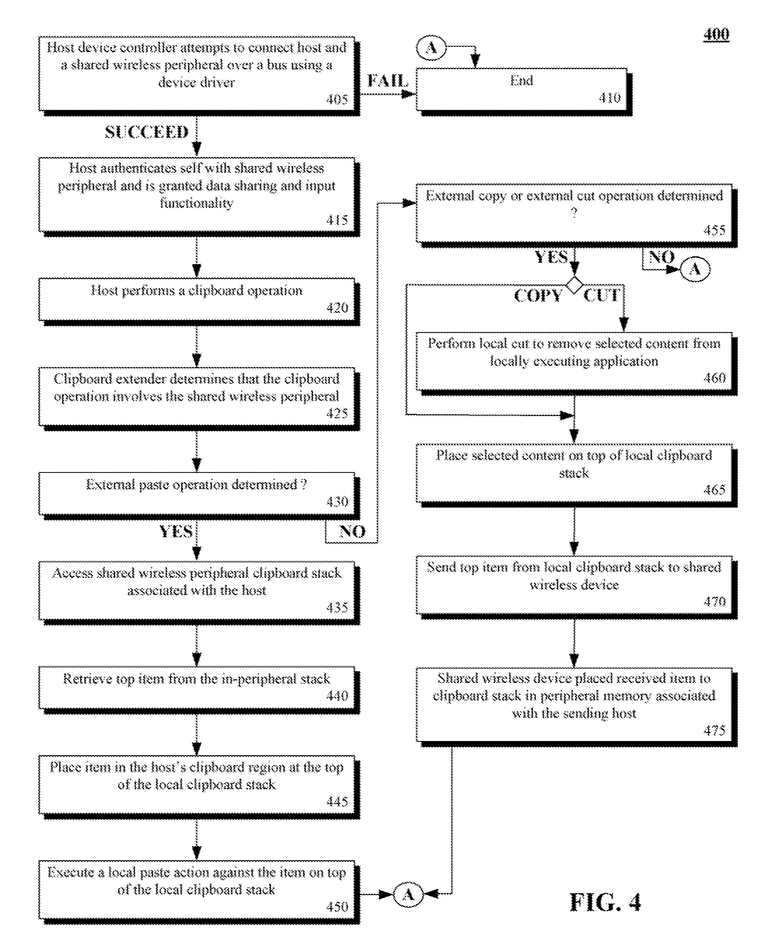

FIG. 4 is a flow chart of a method 400 for using a shared wireless device to permit clipboard operations to convey digital content between different hosts in accordance with an embodiment of the inventive arrangements disclosed herein. The method 400 can be performed in context of system 100. Method 400 illustrates a manner in which a standard clipboard of a host can be extended so that CUT, COPY, and PASTE commands can send/receive information to/from a memory of a shared wireless peripheral. Since the wireless peripheral is shared, the method permits digital content to be conveyed from one host to another over a peripheral interface communication pathway. Thus the method shows how a plug-in extension can be added to a clipboard without substantially modifying a pre-existing clipboard program.

Method 400 can begin in step 405, where a host device controller can attempt to connect a shared wireless peripheral to the host over a bus using a device driver. If this connection attempt fails, the method can end in step 410. If the connection attempt succeeds, the method can proceed to step 315, where the host can authenticate itself with the shared wireless peripheral. When authentication succeeds, the host can be granted data sharing and/or input functionality involving the shared wireless peripheral. When it authentication fails (not shown) the method can end in step 410. After step 415, the host can perform a clipboard operation. In step 425, a clipboard extender program can determine that the clipboard operation involves the shared wireless peripheral. In contract, other clipboard operations can exist that apply only to the host and local data stores, in which case (not shown) the method can end in step 410.

In step 435, it can be determined whether the clipboard operation is a PASTE operation, which causes the method to proceed to step 435. Otherwise, the method can proceed from step 430 to step 455. In step 435, the host can access a clipboard stack contained in a memory of the shared wireless peripheral. In an embodiment where multiple different clipboard stacks are maintained within the in-peripheral memory, the stack associated with the host can be determined and used. In step 440, a top item can be retrieved from the in-peripheral stack. In step 445, the retrieved item can be placed in the host's clipboard region at the top of a local clipboard stack. In step 450, a local paste action can execute against the item on top of the local clipboard stack (i.e., the item retrieved from the in-peripheral memory). The method can then end in step 410.

In step 455, a determination can be made as to whether the clipboard operation is a CUT or COPY operation. If neither, the method can end in step 410. If the clipboard operation is a CUT operation, step 460 can execute that causes a local cut action to be performed that removes selected content from a locally executing application. After step 460 or when a COPY operation is determined, step 465 can execute, which places selected content on top of a local clipboard stack. In step 470, the topmost stack item can also be sent to the shared wireless device. In step 465, the shared wireless device can place the received digital content on top of a clipboard stack maintained in an in-peripheral memory space. This stack can be used when a host, which can be different from a host that performed the CUT or COPY operation, performs a PASTE operation involving the shared wireless peripheral.

It should be appreciated that configurable options can be included to enable/disable redirections to/from the clipboard extension program. It should also be appreciated that the method 300 can be added to source code of a clipboard executable instead of being implemented as an extension to a substantially unmodified pre-existing clipboard program. A pre-existing clipboard program can be substantially unmodified because events that trigger the clipboard extension functions can be based upon monitored conditions specific to a local clipboard memory. For example, the clipboard extension can detect when an item is added to a local clipboard memory region, which can cause the clipboard extension to convey the added item to a memory of the shared wireless peripheral.

In one embodiment, configurable rules can be established to determine a manner in which the clipboard extension is to interact with standard clipboard operations. For example, a rule can exist that causes a local paste operation to use a most recently added item from either the local clipboard or from a clipboard stack of the shared wireless peripheral. That is, a timestamp of the topmost item on the external clipboard stack can be compared to a timestamp of the topmost item on the local clipboard stack. When the external clipboard stack item is later in time, the external item can be copied to the local clipboard stack, and then the local paste operation can execute.

In another embodiment, special clipboard commands can be added to specify whether clipboard actions are to involve an external clipboard of a memory of a shared wireless device. For example, COPY_LOCAL, CUT_LOCAL, and PASTE_LOCAL commands can be added that restrict the clipboard operation to a standard hosts clipboard area. In another example, COPY_EXTERNAL, CUT_EXTERNAL, and PASTE_EXTERNAL commands can be added to explicitly direct clipboard commands to involve a shared wireless device. External commands can be extended to specify a specific shared wireless device (e.g., COPY_EXTERNAL Device_M), in situations where multiple shared wireless devices (e.g., Device_M and Device_N) are within range of a host. The special clipboard commands can be triggered from a pop-up menu, from a hot-key combination, from a selection of a button of the shared wireless peripheral, from a command line entry, and the like.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A shared wireless peripheral comprising:
a memory space of a shared wireless peripheral device configured to store digital content; and
an authentication engine configured to determine whether a host is granted access to the memory space based upon a security artifact received from the host, wherein the shared wireless peripheral device is configured to receive digital content from one host, to store the received digital content in the memory space, and to convey the stored digital content to a different host.

2. The shared wireless peripheral of claim 1, wherein the security artifact comprises user input from an input device of the host other than the shared wireless peripheral device, wherein in absence of the user input, the authentication engine is configured to deny the host access to the memory space.

3. The shared wireless peripheral of claim 1, wherein the security artifact comprises a certificate, wherein in absence of the user input, the authentication engine is configured to deny the host access to the memory space.

4. The shared wireless peripheral of claim 1, wherein said shared wireless peripheral is an input device, said method further comprising:
a memory director configured to manage which of a plurality of possible hosts including the one host and the different host are to be provided access to the memory space; and
an input director configured to manage which of a plurality of possible hosts including the one host and the different host are to be sent input of the shared wireless peripheral, where the sent input results from a user interaction with the shared wireless peripheral.

5. The shared wireless peripheral of claim 1, wherein said shared wireless peripheral is an input device, wherein input that results from a user interaction with the shared wireless peripheral is directed to only one host at a time, wherein a plurality of different hosts are able to access the memory space at the same time.

6. The shared wireless peripheral of claim 1, wherein clipboard operations conducted upon the one host and the different host cause digital content to be conveyed to and from the memory space, wherein clipboard operations comprise a CUT operation, a COPY operation, and a PASTE operation.

7. The shared wireless peripheral of claim 6, further comprising:
a clipboard extension program executing on the one host and the different host, which causes digital content placed in a local clipboard of the one host to be copied into a clipboard area of the memory space, and which causes digital content placed in the memory space to be copied to a local clipboard of the different host, wherein said clipboard extension interacts with pre-existing clipboard software of the one host and the different host without modifying source code of the pre-existing clipboard software, and wherein the pre-existing clipboard software lacks programmatic instructions for interacting with the memory space of the shared wireless peripheral during a clipboard operation.

8. The shared wireless peripheral of claim 1, wherein the shared wireless peripheral is one of a mouse, a trackball, a joystick, and a game controller.

9. The shared wireless peripheral of claim 1, further comprising:
a first wireless transceiver configured to wirelessly exchange digital content between a shared wireless peripheral and a host connecting component; and
a second wireless transceiver contained within the host connecting component configured to be connected to a bus of the host, wherein said bus connects to a device controller of the host that uses a device driver to communicate with the shared wireless peripheral device.

10. The shared wireless peripheral of claim 9, wherein said host connecting component is one of a plurality of host connecting components configured to wirelessly exchange digital content between the host connecting component and the shared wireless peripheral, wherein each of the host connecting components are connected to different hosts including said one host and said different host.

11. A method for using clipboard operations to transfer content between different hosts of a shared wireless peripheral, said method comprising:
authenticating a first host to access a memory space of a shared wireless peripheral communicatively linked to the first host via a bus and a device controller;
selecting digital content displayed within a graphical user interface of the first host;
detecting at least one of a CUT and a COPY clipboard operation conducted from the first host;
copying the selected digital content to the memory space of the shared wireless peripheral;
authenticating a second host to access a memory space of a shared wireless peripheral communicatively linked to the second host via a bus and a device controller;
detecting a PASTE clipboard operation conducted from the second host; and
copying the selected digital content obtained from the first host from the memory space of the shared wireless peripheral to a cursor specified location within a graphical user interface of the second host.

12. The method of claim 11, wherein the authenticating steps require a user input from an input device linked to an authenticating one of the first host and the second host in order for the authenticating steps to be successfully completed, wherein the input device must be an input from a device other than the shared wireless peripheral, wherein requiring the user input from the input device during the authenticating steps ensures a user currently logged onto the authenticating host desires the shared wireless peripheral to be connected to the authenticating host.

13. The method of claim 11, further comprising:
identifying a first security artifact associated with the first host;
encrypting the selected digital content before storing it in the memory space of the shared wireless peripheral, wherein an encryption algorithm used during the encrypting step uses the first security artifact;
identifying a second security artifact associated with the second host; and
decrypting the selected digital content obtained from the memory space of the shared wireless peripheral before copying the selected digital content at the cursor specified location of the graphical user interface of the second host, wherein a decryption algorithm used during the decrypting step uses the second security artifact.

14. The method of claim 11, wherein the first host and the second host are concurrently connected to the memory space of the shared wireless peripheral, wherein the shared wireless peripheral is an input device, wherein input functions of the input device are provided to only one host at a time.

15. The method of claim 11, further comprising:
identifying a plurality of clipboard commands specific to the shared wireless peripheral, wherein at least one of the CUT, COPY, and PASTE clipboard operation is one of the special clipboard commands available for user selection that designates the selected digital content is to be placed or retrieved from the memory space of the shared wireless peripheral.

16. The method of claim 11, wherein said steps of claim 11 are performed by at least one machine in accordance with at least one computer program stored in a computer readable media, said computer programming having a plurality of code sections that are executable by the at least one machine.

17. A software program comprising:
a plurality of programmatic instructions stored on a computing device readable medium, said programmatic instructions being executable by a computing device, wherein said computing device is at least one of a shared wireless peripheral and a host, wherein the programmatic instructions require a user input from an input device connected to the host before digital content is permitted to be exchanged between a data store of the host and a memory space within the shared wireless peripheral, wherein the shared wireless peripheral device is configured to receive digital content from one host, to store the received digital content in the memory space, and to convey the stored digital content to a different host.

18. The software program of claim 17, wherein clipboard operations of the host result in data being exchanged between the data store of the host and the memory space of the shared wireless peripheral.

19. The software program of claim 17, wherein the shared wireless peripheral is one of a mouse, a trackball, a joystick, and a game controller.
